(19) United States
(12) Patent Application Publication
(10) Pub. No.: US 2023/0088480 A1
(43) Pub. Date: Mar. 23, 2023

(54) INTEGRATED CONTROL APPARATUS FOR AUTONOMOUS DRIVING VEHICLE

(71) Applicants: Hyundai Motor Company, Seoul (KR); Kia Corporation, Seoula (KR); SL Corporation, Daegu (KR)

(72) Inventors: Eun Sik KIM, Gwangmyeong-si (KR); Jae Hoon Jung, Gyeongsan-si (KR); Ji Hoon Yang, Gyeongsan-si (KR); Seok Woo Ye, Daegu (KR)

(21) Appl. No.: 17/832,402

(22) Filed: Jun. 3, 2022

(30) Foreign Application Priority Data
Sep. 23, 2021 (KR) 10-2021-0125611

(51) Int. Cl. B60W 60/00; B60K 35/00

(52) U.S. Cl. CPC B60W 60/0053; B60K 35/00; B60K 2370/77; B60K 2370/12

(57) ABSTRACT

An integrated control apparatus for an autonomous driving vehicle is provided. The integrated control apparatus includes a one-hand operation device that a user holds and operates with one hand a two-hand operation device that a user holds and operates with both hand. In the one-hand operation device, a deadman switch is disposed on the front of a grip of the housing under an acceleration trigger switch. In the two-hand operation device, a deadman switch is disposed on the bottom portion of the housing under an acceleration button switch and a brake button switch.

### CROSS REFERENCE TO RELATED APPLICATION

The present application claims priority to Korean Patent Application No. 10-2021-0125611, filed Sep. 23, 2021, the entire contents of which is incorporated herein for all purposes by this reference.

### BACKGROUND OF THE PRESENT DISCLOSURE

### Field of the Present Disclosure

The present disclosure relates to an integrated control apparatus for an autonomous driving vehicle, and more particularly, to an integrated control apparatus which may be directly operated by a user to change an autonomous driving mode into a manual driving mode in an autonomous driving vehicle.

### Description of Related Art

An autonomous driving vehicle is a smart vehicle having autonomous driving technology for going to a destination by itself even though a driver does not manually operate a steering wheel, an accelerator pedal, a brake, etc.

When autonomous driving is generally used, a driver can select a manual driving mode in which the driver manually drives and an autonomous driving mode in which a vehicle drives by itself to a destination without the driver manually driving.

When an emergency occurs during autonomous driving, someone of the passengers in the vehicle has to directly manually operate the vehicle. To the present end, a vehicle has to be provided with an apparatus that a user operates for the manual driving mode.

For example, in some cases, a vehicle manager operates a vehicle in a manual driving mode using a device such as a joystick which is used for game machines.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an integrated control apparatus for an autonomous driving vehicle, the apparatus being able to be directly operated by a user to change an autonomous driving mode into a manual driving mode, and including a one-hand operation device that a user holds and operates with one hand, a two-hand operation device that a user holds and operates with both hands, and a deadman switch disposed at an optimal position where a user conveniently operates the deadman switch on the one-hand operation device and the two-hand operation device to improve convenience of operation.

To achieve the objectives of the present disclosure, an integrated control apparatus, which is provided in an autonomous driving vehicle so that a user can operate the integrated control apparatus to change an autonomous driving mode into a manual driving mode, includes: a housing of a one-hand operation device that the user holds and operates with one hand thereof; and a steering dial switch, a shift slide switch, an acceleration trigger switch, a brake button switch, and a deadman switch that are disposed at the housing, in which the deadman switch is disposed at a portion of the housing that a driver holds.

The one-hand operation device may include: a grip which is configured to be held by one hand of the user and at which the deadman switch is disposed; and a switch section which is elongated in a longitudinal direction of the grip and at which the steering dial switch, the shift slide switch, the acceleration trigger switch, and the brake button switch are disposed.

The one-hand operation device may include a printed circuit board (PCB) fixed to the housing and configured for generating operation signals for the steering dial switch, the shift slide switch, the acceleration trigger switch, the brake button switch, and the deadman switch.

The deadman switch may include: a hinge pin coupled to left and right of the grip of the housing; a deadman key coupled to the hinge pin, elongated up and down, and configured to rotate on the hinge pin with respect to the housing when being operated; and a tact switch connected to a PCB of the one-hand operation device and configured to output a signal by coming in contact with the deadman key when the deadman key is operated.

The integrated control apparatus may further include a rubber damper coupled to the deadman key and configured to prevent noise and a gap and to fix a position of the deadman key by coming in contact with a housing protrusion formed in the housing when the deadman key is operated.

The position of the deadman key may be fixed by an elastic force of the tact switch and a reaction force of the rubber damper, and a magnitude of a moment by the elastic force of the tack switch and a magnitude of a moment by the reaction force of the rubber damper may be the same when the deadman key is not operated.

The deadman key may include: a hinge portion at a first end portion to which the hinge pin is coupled; a switch contact protrusion protruding toward the tact switch at a position spaced from the hinge portion and coming in contact with the tact switch when the deadman key is operated; and a damper coupling portion protruding away from the switch contact protrusion from the hinge portion and coupled with the rubber damper.

The deadman key may include: a hinge portion at a first end portion to which the hinge pin is coupled; a switch contact protrusion protruding toward the tact switch at a position spaced from the hinge portion and coming in contact with the tact switch when the deadman key is operated; and a damper coupling portion protruding from the hinge portion toward the switch contact protrusion and coupled with the rubber damper.

A distance from the hinge portion to the switch contact protrusion may be greater than a distance from the hinge portion to the rubber damper.

A left and right length and a front and rear length of the first end portion at which the hinge portion of the deadman key is positioned may be smaller than those of a second end portion at which the switch contact portion is positioned to prevent interference with a surrounding; and a left and right length and a front and rear length of the second end portion at which the switch contact portion is positioned may be greater than those of the first end portion at which the hinge portion is positioned for convenience of operation.

An integrated control apparatus according to an exemplary embodiment of the present disclosure, which is provided in an autonomous driving vehicle so that a user can operate the integrated control apparatus to change an autonomous driving mode into a manual driving mode, includes: a housing of a two-hand operation device that a user holds and operates with both hands thereof; and a steering dial switch, an acceleration button switch, a brake button switch, a shift slide switch, and a deadman switch that are disposed at the housing, in which the deadman switch is disposed at a portion of the housing that a driver holds.

The deadman switch may be disposed on a bottom portion of the housing to be positioned under the acceleration button switch and the brake button switch.

The housing of the two-hand operation device may include: a first grip that the user holds with one hand; a second grip which is spaced from the first grip and that the user holds with the other hand; and a switch section that connects the first grip and the second grip to each other and at which the steering dial switch, the acceleration button switch, the brake button switch, the shift slide switch, the deadman switch, and a display are disposed.

The steering dial switch may protrude upwards from the switch section, may be disposed at a front portion of the first grip, and may be rotated to be operated by a user; the acceleration button switch and the brake button switch may protrude upwards from the switch section, may be disposed at a front portion of the second grip, and may be pressed to be operated by a user; and the shift slide switch may protrude forward from a front of the switch section and may be pushed or pulled to be operated by a user.

The two-hand operation device may include a PCB fixed to the housing and generating operation signals for the steering dial switch, the acceleration button switch, the brake button switch, the shift slide switch, and the deadman switch.

The deadman switch may include: a hinge pin coupled to the housing in a front and rear direction thereof; a deadman key including a side coupled to the hinge pin, including another side laterally elongated, and configured to rotate on the hinge pin with respect to the housing when being operated; and a tact switch connected to the PCB of the two-hand operation device and configured to output a signal by coming in contact with the deadman key when the deadman key is operated.

The integrated control apparatus may further include a rubber damper coupled to the housing and configured to prevent noise and a gap and to fix a position of the deadman key by coming in contact with the deadman key when the deadman key is operated.

The position of the deadman key may be fixed by an elastic force of the tact switch and a reaction force of the rubber damper, and a magnitude of a moment by the elastic force of the tack switch and a magnitude of a moment by the reaction force of the rubber damper may be the same when the deadman key is not operated.

The deadman key may include: a hinge portion at the first end portion to which the hinge pin is coupled; a switch contact protrusion protruding toward the tact switch at the second side of the deadman key spaced from the hinge portion, and coming in contact with the tact switch when the deadman key is operated; and a damper contact portion protruding from the first side of the deadman key at which the hinge portion is positioned, and coming in contact with the rubber damper when the deadman key is operated.

A distance from the hinge portion to the switch contact protrusion may be greater than a distance from the hinge portion to the damper contact portion.

An integrated control apparatus for an autonomous driving vehicle according to an exemplary embodiment of the present disclosure includes a one-hand operation device that a user holds and operates with one hand a two-hand operation device that a user holds and operates with both hands. In the one-hand operation device, a deadman switch is disposed on the front of a grip of the housing under an acceleration trigger switch. In the two-hand operation device, a deadman switch is disposed on the bottom portion of the housing under an acceleration button switch and a brake button switch. Accordingly, there is an effect that a user can more conveniently operate the deadman switch, whereby convenience of operation can be improved.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing an autonomous driving vehicle provided with a one-hand operation device according to various exemplary embodiments of the present disclosure;

FIG. 2 is a view showing a one-hand operation device provided with a deadman switch according to an exemplary embodiment of the present disclosure;

FIG. 3, FIG. 4, and FIG. 5 are a side view and a front view of FIG. 2 and a view in which a housing is separated, respectively;

FIG. 6, FIG. 7, and FIG. 8 are views showing a steering dial switch;

FIG. 9 is a view showing a shift slide switch;

FIG. 10 is a view showing a brake button switch;

FIG. 11, FIG. 12, FIG. 13 and FIG. 14 are views showing a deadman switch of a one-hand operation unit according to an exemplary embodiment of the present disclosure;

FIG. 15 is a view showing an autonomous driving vehicle provided with a two-hand operation device according to various exemplary embodiments of the present disclosure;

FIG. 16 is a perspective view of the two-hand operation device according to an exemplary embodiment of the present disclosure;

FIG. 17 is a perspective view of FIG. 16 seen from the front;

FIG. 18 and FIG. 19 are a plan view and a right side view of FIG. 16;

FIG. 20 is a view with a housing removed in FIG. 17;

FIG. 21 is an exploded view of FIG. 20; and

FIG. 22, FIG. 23, FIG. 24, FIG. 25 and FIG. 26 are views showing a deadman switch of a two-hand operation device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description, the structural or functional description specified to exemplary embodiments according to the concept of the present disclosure is directed to describe the exemplary embodiments of the present disclosure, so it should be understood that the present disclosure may be variously embodied, without being limited to the exemplary embodiments of the present disclosure.

Embodiments described herein may be changed in various ways and various shapes, so specific embodiments are shown in the drawings and will be described in detail in the exemplary embodiment of the present disclosure. However, it should be understood that the exemplary embodiments according to the concept of the present disclosure are not limited to the embodiments which will be described hereinbelow with reference to the accompanying drawings, but all modifications, equivalents, and substitutions are included in the scope and spirit of the present disclosure.

It will be understood that, although the terms first, second, etc. may be used herein to describe various elements, these elements should not be limited by these terms. These terms are only used to distinguish one element, from another element. For instance, a first element discussed below could be termed a second element without departing from the right range of the present disclosure. Similarly, the second element could also be termed the first element.

It is to be understood that when one element is referred to as being “connected to” or “coupled to” another element, it may be directly connected to or directly coupled to another element or be connected to or coupled to another element, including the other element intervening therebetween. On the other hand, it may to be understood that when one element is referred to as being “directly connected to” or “directly coupled to” another element, it may be connected to or coupled to another element without the other element intervening therebetween. Furthermore, the terms used herein to describe a relationship between elements, that is, “between”, “directly between”, “adjacent”, or “directly adjacent” should be interpreted in the same manner as those described above.

Terms used in an exemplary embodiment of the present disclosure are used only to describe predetermined exemplary embodiments rather than limiting the present disclosure. Singular forms are intended to include plural forms unless the context clearly indicates otherwise. It will be further understood that the terms “comprises” or “have” used in the exemplary embodiment specify the presence of stated features, numerals, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which an exemplary embodiment of the present disclosure belongs. It must be understood that the terms defined by the dictionary are identical with the meanings within the context of the related art, and they should not be ideally or excessively formally defined unless the context clearly dictates otherwise.

A control unit (controller) according to exemplary embodiments of the present disclosure may be implemented through a nonvolatile memory configured to store algorithms for controlling operation of various components of a vehicle or data about software commands for executing the algorithms, and a processor configured to perform operation to be described below using the data stored in the memory. The memory and the processor may be individual chips. Alternatively, the memory and the processor may be integrated in a single chip. The processor may be implemented as one or more processors.

An integrated control apparatus for an autonomous driving vehicle according exemplary embodiments of the present disclosure is described hereafter in detail with reference to the accompanying drawings.

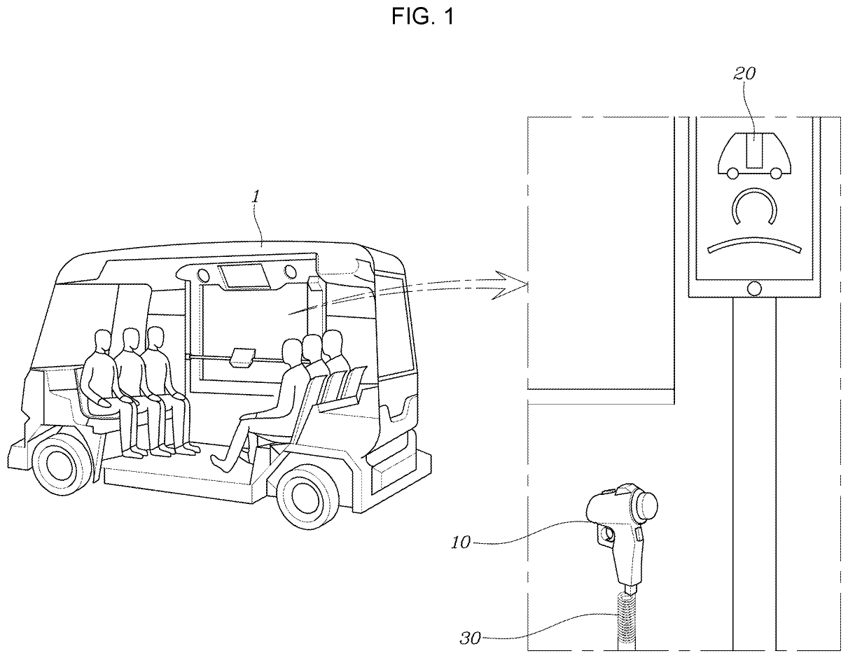

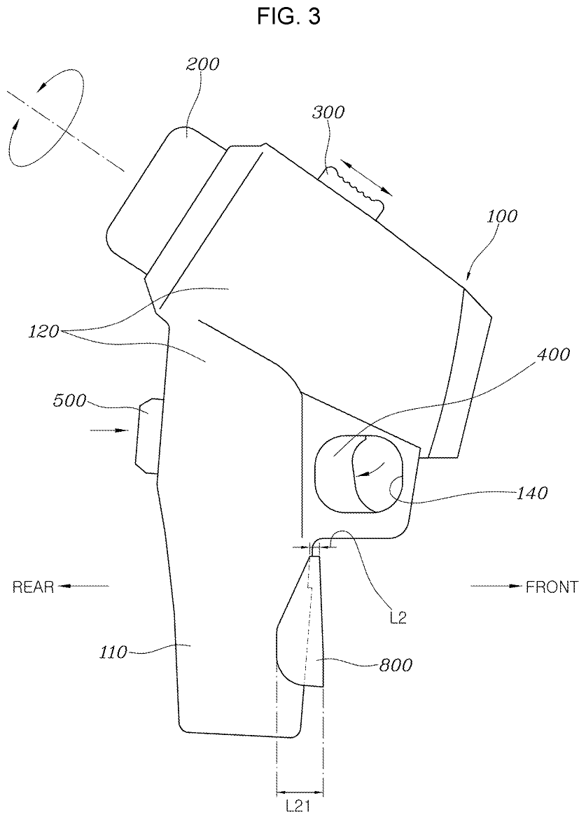

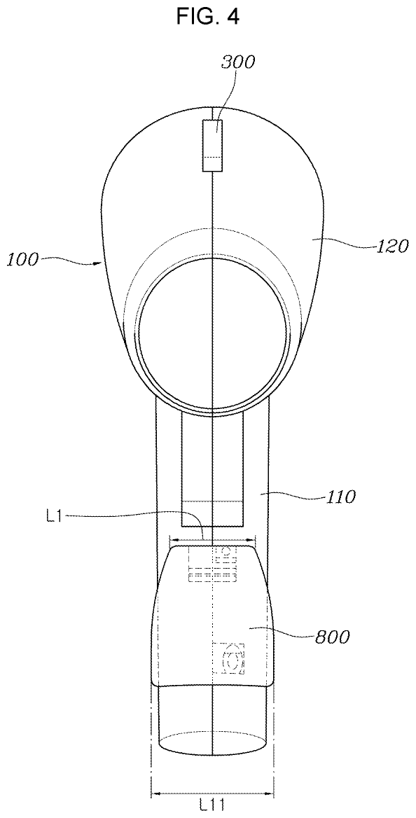

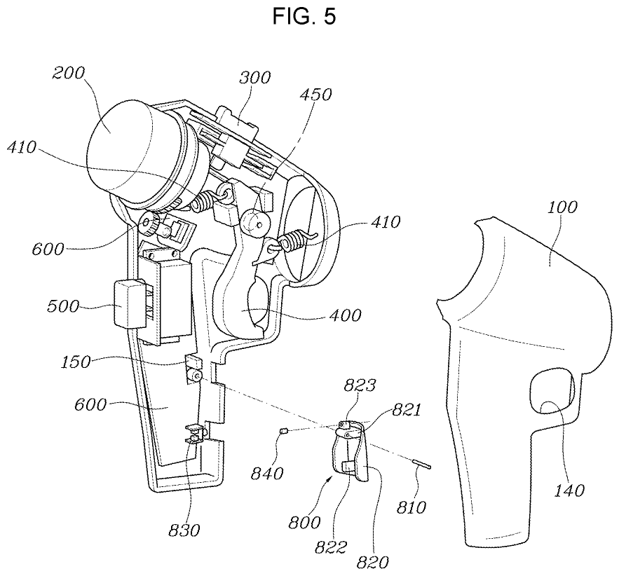

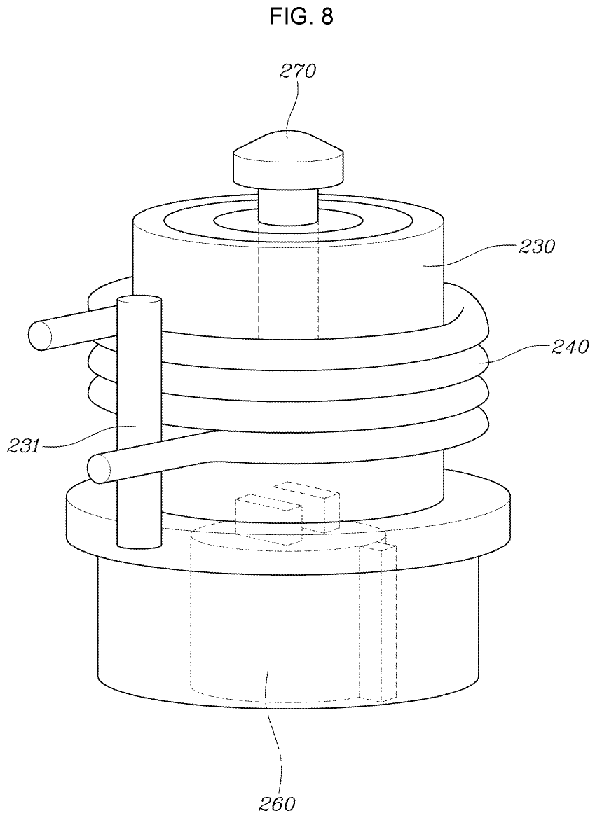

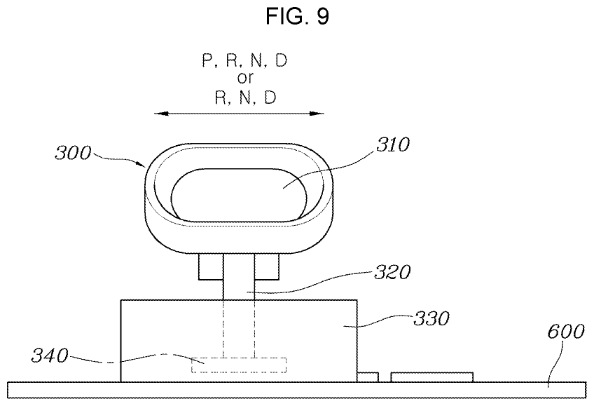

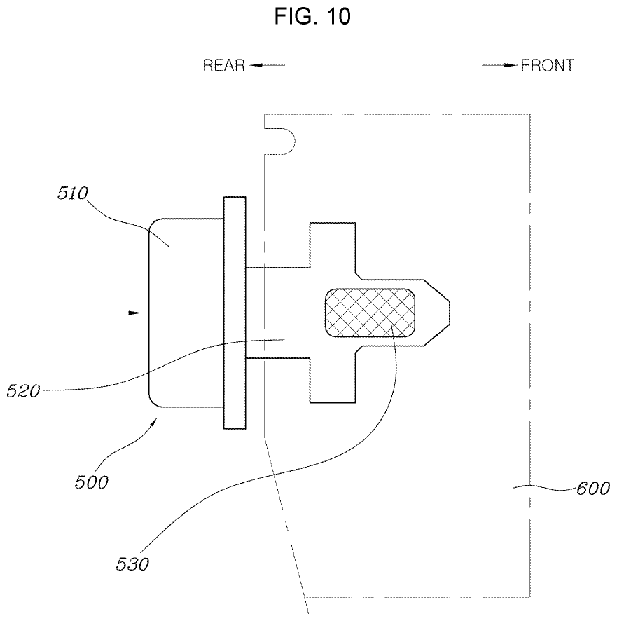

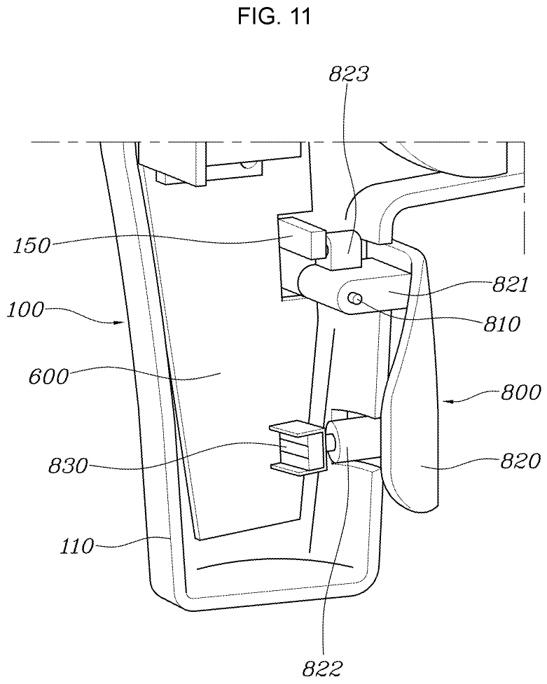

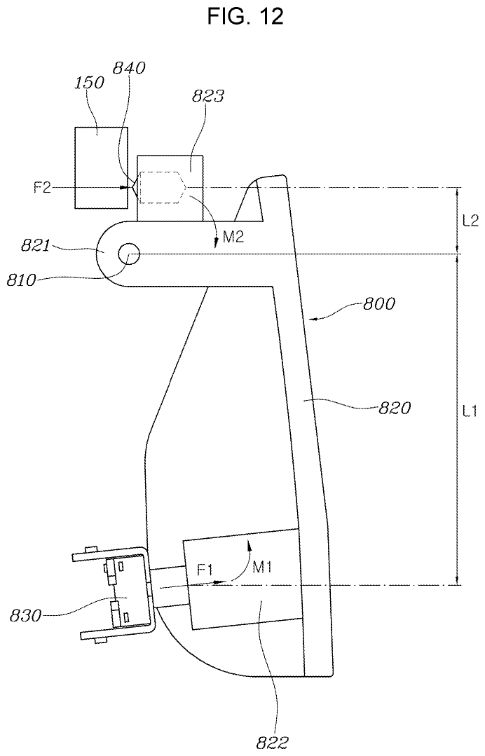

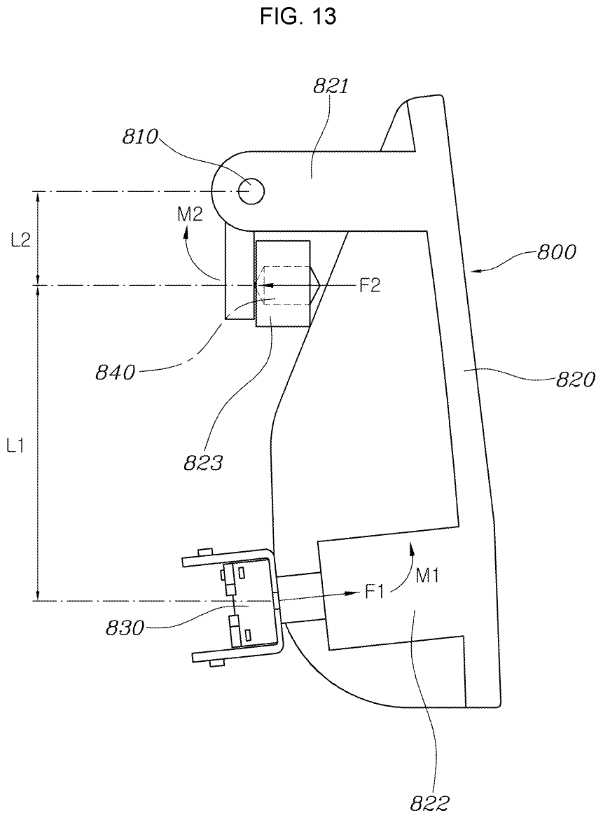

An integrated control apparatus for an autonomous driving vehicle according to various exemplary embodiments of the present disclosure is an apparatus that is, as shown in FIGS. 1 to 14, disposed in an autonomous driving vehicle 1 and enables a manager of the vehicle to drive the vehicle in a manual driving mode by operating the apparatus when an emergency occurs during autonomous driving.

That is, the integrated control apparatus for an autonomous driving vehicle according to various exemplary embodiments of the present disclosure may include a movable operation device that a user holds with one hand 2 and operates for steering, shifting, accelerating, and braking; and a fixed display 20 which is separated from the movable operation device and a user operates in a touch type for functions other than steering, shifting, accelerating, and braking.

The movable operation device is one-hand operation device that a user holds and operates with one hand 2 and is a portable operation device that a user can hold and move to a desired position with one hand 2.

The fixed display 20 is a device fixed in the interior of the autonomous driving vehicle 1, and the one-hand operation device 10 and the fixed display 20 are separate devices.

The one-hand operation device 10 may be referred to as a lever-type operation device, depending on the external shape.

The other functions that are achieved through the fixed display 20 include a function of operating lamps mounted on the front and rear of the vehicle, a function of generating an alarm, and a function of changing the driving mode.

The lamps of the vehicle include all kinds of lamps that are mounted on the vehicle, that is, may include headlamps, fog lamps, turn signals, tail lamps, warning lights, etc.

The driving mode which is changed includes an autonomous driving mode and a manual driving mode.

According to various exemplary embodiments of the present disclosure, steering, shifting, accelerating, and braking of a vehicle are performed by operating the one-hand operation device 10 which is a movable operation device and other functions of the vehicle are performed by operating the touch-type fixed display 20, so there is an advantage that operation is convenient. There is an advantage that because various functions of the vehicle are separately performed through the one-hand operation device 10 and the touch-type fixed display 20, mis-operation is maximally prevented.

There is another advantage that the one-hand operation device 10, which is a portable device that a user can hold and move to a desired position with a hand, may be easily operated because the volume and weight are small.

The one-hand operation device 10 according to various exemplary embodiments of the present disclosure may include a housing 100 that a user holds with one hand 2; and a steering dial switch 200, a shift slide switch 300, an acceleration trigger switch 400, a brake button switch 500, and a deadman switch 800 that are disposed at the housing 100.

The housing 100 has: a grip 110 that has a straight box structure, is a portion that a user holds with one hand 2, and at which the deadman switch 800 is disposed; and a switch section 120 which is elongated in the longitudinal direction of the grip 110 and at which the steering dial switch 200, the shift slid switch 300, the acceleration trigger switch 400, and the brake button switch 500 are disposed.

The housing 100 forms the external appearance, protects the portions therein from shock, and includes a left housing and a right housing that are separably combined.

The one-hand operation device 10 is connected to the autonomous driving vehicle 1 through a spring wire 30 and both end portions of the spring wire 30 are connected to the one-hand operation device 10 and the autonomous driving vehicle 1 through a separable connector structure.

The one-hand operation device 10 is a portable operation device that a vehicle manager who is a user can hold and move to a desired position with one hand 2 and the spring wire 30 is prevented from sagging because of its tension even though the one-hand operation device 10 is moved, so that the spring wire 30 may be prevented from being stepped on, whereby damage due to disconnection may be prevented. Accordingly, there is an advantage that it is advantageous in terms of safety.

The connector structure of the spring wire 30 has a locking structure, the spring wire 30 is not separated from the one-hand operation device 10 and the vehicle body of the autonomous driving vehicle unless the connector structure is unlocked.

The steering dial switch 200 is disposed at the upper end portion of the rear surface of the housing 100 when a user holds the grip 100 with one hand 2 and the user operates the steering dial switch 200 by rotating it clockwise or counterclockwise with the other hand not holding the grip 110.

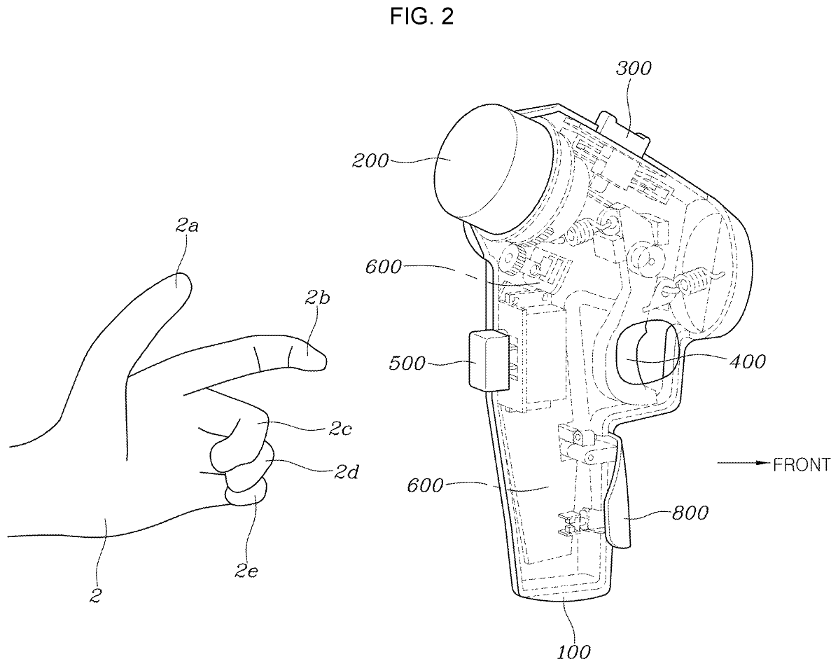

When a user holds the grip 110 with the left hand the switch section 120 is elongated over the grip 110, as shown in FIG. 2, the steering dial switch 200 protrudes toward the user's body from the uppermost position of the rear surface of the switch section 120 to be configured to be rotated in a dial type. Furthermore, the use can operate the steering dial switch 200 by rotating it clockwise or counterclockwise with the fingers or the entire of the other hand not holding the housing 100, that is, the right hand.

When a user operates the steering dial switch 200, the steering dial switch 200 is rotated clockwise or counterclockwise with respect to the housing 100, and when the user releases the steering dial switch 200, the steering dial switch 200 is rotated in the opposite direction and returned to the initial position by the spring force of a return spring 240.

The steering dial switch 200 includes a damper 260 that decreases the return speed by the spring force of the return spring 240 and the damper 260 is coaxially provided in the steering dial switch 200. Because the damper 260 is provided in the steering dial switch 200, it is possible to reduce the external size of the steering dial switch 200, so there is an advantage that the steering dial switch 200 may be made compact.

The steering dial switch 200 is configured to be exposed out of the housing 100 through the rear surface facing a user at the upper portion of the switch section 120.

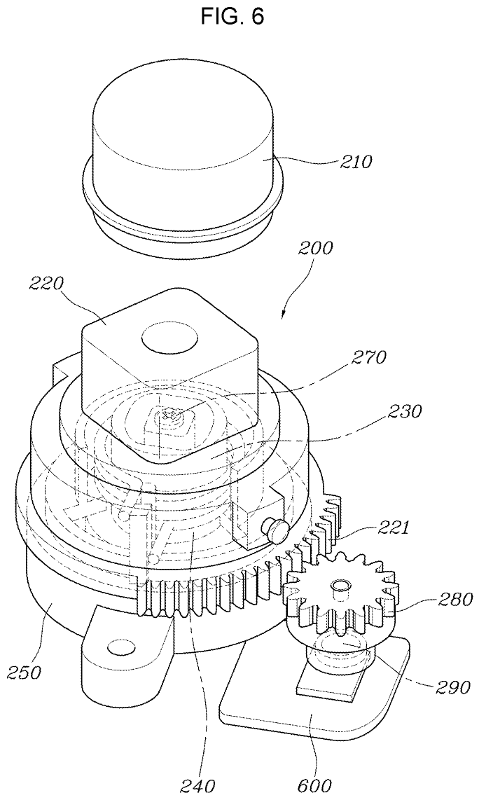

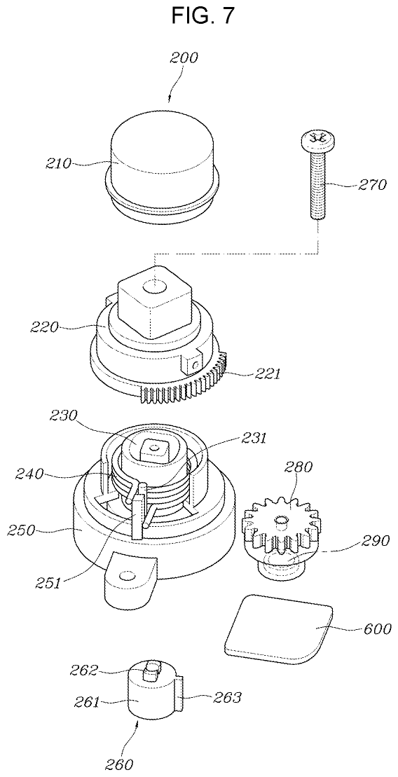

The steering dial switch 200, as shown in FIGS. 6 to 8, includes a steering knob 210, a base gear 220, a rotation element 230, a return spring 240, an external case 250, a damper 260, a dial shaft 270, a sensing gear 280, and a permanent magnet 290.

The steering knob 210 which is the portion configured to be rotated by a user, the steering knob 210 and the base gear 220 are coupled to each other and integrally rotated, and gear teeth 221 are circumferentially formed on the base gear 220.

The external case 250 is coupled and fixed to the housing 100 and the rotation element 230 is rotatably disposed in the external case 250.

A spring operation protrusion 231 and a stopper protrusion 251 that protrude in the same direction are formed on the rotation element 230 and the external case 250, respectively.

The return spring 240 is wound on the rotation element 230, both end portions of the return spring 240 are supported on the external surfaces of the stopper protrusion 251, and the spring operation protrusion 231 is positioned between both end portions of the return spring 240.

The damper 260 is called a micro damper and includes an external fixer 261 and an internal rotor 262, and the portion between the external fixer 261 and the internal rotor 262 is filled with silicone oil, whereby damping force is generated.

The damper 260 is disposed inside the rotation element 230, the external fixer 261 of the damper 260 is coupled to the housing 100, a key 263 protruding outward is formed on the external fixer 261, and a key groove is formed on the housing 100. Accordingly, when the key 263 is inserted into the key groove, the external fixer 261 of the damper 260 is coupled and fixed to the housing 100.

The dial shaft 270 is coupled to the internal rotor 262 of the damper 260 through the centers of the base gear 220 and the rotation element 230 and the steering knob 210 is coupled to the base gear 220 after the dial shaft 270 is coupled, whereby exposure of the dial shaft 270 is prevented.

The sensing gear 280 is engaged with the gear teeth 221 of the base gear 220 like an external gear and the permanent magnet 290 is coupled to the rotational center portion of the sensing gear 280 to face a Printed Circuit Board (PCB) 600.

According to an exemplary embodiment of the present disclosure, because the damper 260 is provided inside the steering dial switch 200, it is possible to reduce the external size of the steering dial switch 200, so that the steering dial switch 200 may be made compact.

Furthermore, according to an exemplary embodiment of the present disclosure, because the damper 260 may be operated by restriction force of the dial shaft 270, a gear structure is not used, so there is an advantage that the cost for precise molds may be saved, it is possible to prevent pulsation noise due to a gear structure when the damper 260 is rotated.

The damper 260 reduces the return speed by the spring force of the return spring 240, preventing noise and shock.

When a user rotates the steering dial switch 200 clockwise or counterclockwise, the permanent magnet 290 is rotated by a rotation of the sensing gear 280 and the PCB 600 recognizes rotation of the steering dial switch 200 from a change of the magnetic flux generated by a rotation of the permanent magnet 290 and generates a signal related to steering.

Furthermore, when a user rotates the steering dial switch 200 clockwise or counterclockwise, the return spring 240 is compressed and keeps elasticity. When the user releases the steering dial switch 200, the steering dial switch 200 is rotated in the opposite direction and returned to the initial position by the spring force of the return spring 240.

A power handle may be additionally provided at the steering dial switch 200. The top portion of the power handle may be exposed out of the steering dial switch 200.

The top portion of the power handle is concaved so that a user can put a finger thereon, so when a user puts the index finger or the thump of the left hand on the top portion of the power handle and applies a small rotational force, the entire steering dial switch 200 may be rotated with respect to the housing 100.

The shift slide switch 300 is disposed on the top portion of the switch section 120 and a user can operate the shift slide switch 300 by putting the thumb or the index finger of the other hand not holding the grip 110, that is, the right hand on the shift slide switch 300 and pushing forward or pull backward the finger.

The shift slide switch 300 may be configured to select any one of four shifting ranges (a P-range, an R-range, an N-range, and a D-range) or to select any one of three shifting ranges (an R-range, an N-range, and a D-range) when it is operated.

When the shift slide switch 300 is configured to select any one of three shifting ranges (an R-range, an N-range, and a D-range) when it is operated, the movement distance of the shift slide switch 300 may be reduced, so there is an advantage that the size of the shift slide switch 300 can also be decreased.

When the shift slide switch 300 is configured to select any one of three shifting ranges (an R-range, an N-range, and a D-range) when it is operated, a menu for selecting a P-range may be added in the fixed display 20. Accordingly, there is an advantage that anyone of the passengers in an autonomous driving vehicle other than the vehicle manager can shift into the P-range in an emergency, so that the possibility of an accident may be reduced.

Furthermore, when the shift slide switch 300 is configured to select any one of three shifting ranges (an R-range, an N-range, and a D-range) when it is operated, the brake button switch 500 may be configured to select the P-range when it is operated over a predetermined time period after the shift slide switch 300 slides to the N-range.

That is, the shift slide switch 300 slides to the N-range and then the engine of the vehicle is turned off so that the vehicle is parked with the N-range engaged. In the instant state, when the brake button switch 500 is operated over 3 seconds, the P-range is engaged, so that the vehicle is finally parked with the P-range engaged.

Because the shift slide switch 300 is provided on the top portion of the switch section 120, a user operates the shift slide switch 300 by holding the grip 110 with the left hand pushing forward or pulling backward the shift slide switch 300 with the thumb or the index finger of the right hand.

The knob 310 of the shift slide switch 300 is integrated with a rod 320, the rod 320 is configured to be able to reciprocate straightly with respect to a switch body 330, and a permanent magnet 340 is coupled to the rod 320 to face the PCB 600.

A groove structure is formed in the switch body 330, so that the position of the rod 320 may be fixed when the knob 310 is operated. The switch body 330 has a spring, so an operation force may be generated.

When a user holds the grip 110 of the housing 100 with the left hand pushes forward or pulls backward the knob 310 of the shift slide switch 300 with the index finger or the thumb of the right hand, the position of the permanent magnet 340 is changed by movement of the rod 320 and the PCB 600 recognizes movement of the shift slide switch 300 from a change of the magnetic flux due to the position change of the permanent magnet 340 and generates a signal related to shifting.

The acceleration trigger switch 400 is disposed closest to the grip 100 of the switch section 120 and a user can operate the acceleration trigger switch 400 with the index finger 2b of the hand holding the grip 110, that is, the left hand.

A user can operate the acceleration trigger switch 400 by holding the grip 100 with the left hand like holding a gun, passing the index finger 2b of the left hand laterally through the housing 100, and then folding the index finger 2b backward like pulling a trigger.

A housing hole 140 is formed at the housing 100 so that a user can laterally pass the index finger of the left hand holding the housing 100 through the housing hole 140.

The upper portion of the acceleration trigger switch 400 may be rotated forwards and backwards with respect to the housing 100 and the lower portion thereof is operated by the index finger 2b of the user's left hand.

A return spring 410 is connected to the acceleration trigger switch 400 in the front and rear direction to provide an operation feeling and a return force of the acceleration trigger switch 400.

A permanent magnet 450 is coupled to the rotational center portion of the acceleration trigger switch 400 to face the PCB 600. Accordingly, when a user holds the grip 110 of the housing 100 with the left hand pulls the acceleration trigger switch 400 with the index finger 2b of the left hand, the permanent magnet 450 is rotated and the PCB 600 recognizes rotation of the acceleration trigger switch 400 from a change of the magnetic flux due to rotation of the permanent magnet 450 and generates a signal related to acceleration.

The brake button switch 500 is disposed on the rear surface of the housing 100 when a user holds the grip 110 with one hand 2 and a user can operate the brake button switch 500 by pressing the brake button switch 500 with a finger of the hand holding the grip 110.

That is, a user may hold the grip 110 with the left hand like holding a gun, operate the acceleration trigger switch 400 with the index finger 2b of the left hand, and operate the brake button switch 500 on the rear surface of the housing 100 by pressing the brake button switch 500 with the thumb 2a of the left hand.

The brake button switch 500 includes a knob 510 configured to be operated by a user and a slider 520 coupled to the knob 510 to move together. The knob 510 is configured to be externally exposed through the rear surface of the housing 100 and the slider 520 is configured to slide forwards and backwards in the housing 100.

A permanent magnet 530 is coupled to the slider 520 to face the PCB 600. Accordingly, when a user holds the grip 110 of the housing 100 with the left hand presses the brake button switch 500 with the index finger 2a of the left hand, the position of the permanent magnet 530 is changed and the PCB 600 recognizes movement of the brake button switch 500 from a change of the magnetic flux due to the position change of the permanent magnet 530 and generates a signal related to braking.

A braking-fixing bracket is used to prevent separation of the brake button switch 500 and is coupled to a fixed to the housing 100 while covering a side of the slider 520 to which the permanent magnet 530 is coupled.

The brake button switch 500 has a spring, so it is returned to the initial position by a spring force when it is operated.

When a user simultaneously operates the acceleration trigger switch 400 and the brake button switch 500, the PCB 600 recognizes and processes first the signal from the brake button switch 500, whereby it is possible to prevent an accident caused by mis-operation and rapid acceleration.

The present disclosure is characterized in that the steering dial switch 200, the shift slide switch 300, the acceleration trigger switch 400, and the brake button switch 500 are operated in different ways, so intuitiveness is improved when they are operated, whereby mis-operation may be prevented.

The one-hand operation device 10 according to an exemplary embodiment of the present disclosure includes a PCB 600 which is fixed to the housing 100 and generates operation signals of the steering dial switch 200, the shift slide switch 300, the acceleration trigger switch 400, the brake button switch 500, and the deadman switch 800.

The deadman switch 800 of the one-hand operation device 10 is disposed at the grip 110 of the housing 100 and may be positioned under the acceleration trigger switch 400 on the front surface of the housing 100.

The deadman switch 800 is positioned under the acceleration trigger switch 400 on the front surface of the housing 100 when a user holds the grip 110 with one hand 2 and a user can operate the deadman switch 800 by pressing the deadman switch 800 with a finger of the hand holding the grip 110.

That is, a user operate the deadman switch 800 by holding the grip 110 with the left hand like holding a gun and then pressing the deadman switch 800 with any one of the middle finger 2c, the ring finger 2d, and the little finger 2e or one or more of the middle finger 2c, the ring finger 2d, and the little finger 2e.

Because the deadman switch 800 is positioned under the acceleration trigger switch 400 on the front surface of the housing 100 of the one-hand operation device 10, a user can more conveniently operate the deadman switch 800, whereby convenience of operation may be considerably improved.

The deadman switch 800 is a switch configured to be operated by a user for steering, shifting, accelerating, and braking. Only when a user operates the steering dial switch 200, the shift slide switch 300, the acceleration trigger switch 400, or the brake button switch 500 after operating the deadman switch 800, the function of the operated switch is performed.

When a user operates the steering dial switch 200, the shift slide switch 300, the acceleration trigger switch 400, or the brake button switch 500 without operating the deadman switch 800, the function of the operated switch is not performed and a warning (texts, symbols, etc.) is provided to the user.

That is, the functions corresponding to steering, shifting, accelerating, and braking of a vehicle are important main factors that are directly connected with safety of passengers. Accordingly, a user has to operate desired switches (steering, shifting, accelerating, and braking switches) after operating the deadman switch 800 first when operating the steering dial switch 200, the shift slide switch 300, the acceleration trigger switch 400, and the brake button switch 500 in consideration of safety of passengers.

However, when a user operates normal function switches, the functions of the operated normal function switches are immediately performed regardless of operation of the deadman switch 800.

That is, the functions corresponding to lamps, a horn, and turn signals of a vehicle are sub-factors that are not directly connected with safety of passengers. Accordingly, when a user operates normal function switches after operating the deadman switch 800, the functions of the operated normal function switches are immediately performed, and even though a user operates the normal function switches without operating the deadman switch 800, the functions of the operated normal function switches are immediately performed.

The deadman switch 800 includes: a hinge pin 810 coupled to the left and right of the grip 110 of the housing 100; a deadman key 820 coupled to the hinge pin 810, elongated up and down, and configured to rotate on the hinge pin 810 with respect to the housing 100 when it is operated; and a tact switch 830 connected to the PCB 600 of the one-hand operation device 100 and outputting a signal by coming in contact with the deadman key 820 when the deadman key 820 is operated.

The deadman key 820 is formed like a lever and is rotated on the hinge pin 810 coupled to an end portion thereof. Such a rotation type has an advantage that there is no gap in comparison to a sliding type structure, so the present type is suitable for the deadman key.

The tact switch 830 is a switch configured to operate only when coming in contact with the deadman key 820, is small in size, and includes a rubber spring therein, so it has a structure which may be returned. Furthermore, the tact switch 830 outputs a signal in a contact point type when it is operated.

The deadman switch 800 according to an exemplary embodiment of the present disclosure further includes a rubber damper 840 coupled to the deadman key 820 and configured to prevent noise and a gap and to fix the position of the deadman key 820 by coming in contact with a housing protrusion 150 formed in the housing 100 when the deadman key 820 is operated.

Although a spring may be used instead of the rubber damper 840 to prevent a gap around the deadman key 820, the rubber damper 840 has an advantage that the price is low and the layout may be minimized in comparison to a spring.

Referring to FIG. 12, the position of the deadman key 820 is fixed by the elastic force F1 of the tack switch 830 and the reaction force F2 of the rubber damper 840.

The magnitude of the moment M1 by the elastic force F1 of the tack switch 830 and the magnitude of the moment M2 by the reaction force F2 of the rubber damper 840 are the same, and the moments M1 and M2 act in opposite directions with the hinge pin 810 therebetween.

Accordingly, the deadman key 820 is maintained at a predetermined return position when a user does not operate the deadman key 820.

F1*L1=F2*L2, that is, M1=M2.

The deadman key 820 has: a hinge portion 821 at a first end portion to which the hinge pin 810 is coupled; a switch contact protrusion 822 protruding toward the tact switch 830 at a position spaced from the hinge portion 821 and coming in contact with the tact switch 830 when the deadman key 820 is operated; and a damper coupling portion 823 protruding away from the switch contact protrusion 822 from the hinge portion 821 and coupled with the rubber damper 840.

The damper coupling portion 823 may protrude toward the switch contact portion 822 from the hinge portion 821.

The present disclosure is characterized in that the distance from the hinge portion 821 to the switch contact portion 822 is greater than the distance from the hinge portion 821 to the rubber damper 823.

That is, the rubber damper 823 is positioned close to the hinge portion 821 to prevent noise and a gap, and the switch contact portion 822 is positioned far from the hinge portion 821 to improve convenience of operation.

The left and right length L1 and the front and rear length L2 of the first end portion at which the hinge portion 821 of the deadman key 820 is positioned is smaller than those of a second end portion at which the switch contact portion 822 is positioned to prevent interference with the surrounding. The left and right length L11 and the front and rear length L21 of the second end portion at which the switch contact portion 822 is positioned are greater than those of the first end portion at which the hinge portion 821 is positioned for convenience of operation.

In the deadman key 820, the portion close to the hinge portion 821 is made narrow for smooth operation without interference with surrounding portions. The portion at which the switch contact portion 822 is positioned far from the hinge portion 821 is made relatively wide to cover the tact switch 830 and enable a user to easily operate the deadman key 820 with a finger.

In the deadman key 820, as shown in FIG. 12, the damper coupling portion 823 is positioned higher than the hinge portion 821 and the switch contact portion 822 is positioned lower than the hinge portion 821. Alternatively, as shown in FIG. 13, the switch contact portion 822 may be positioned lower than the hinge portion 821 and the damper coupling portion 823 may be positioned between the hinge portion 821 and the switch contact portion 822.

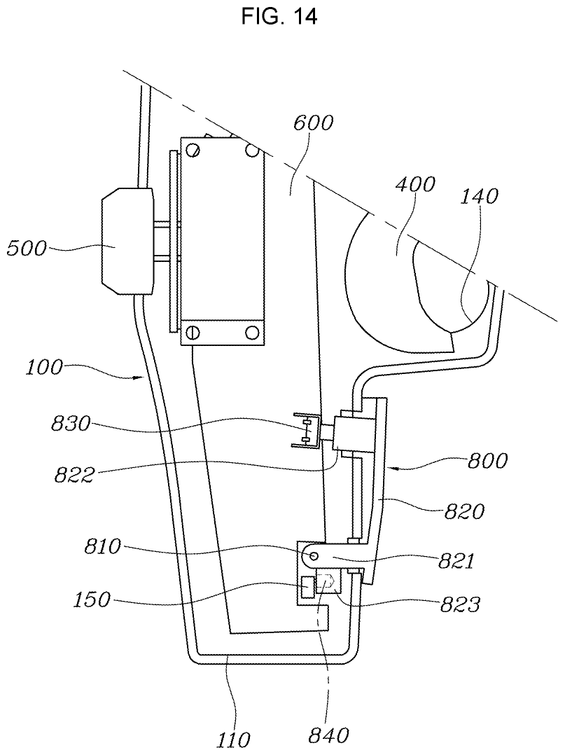

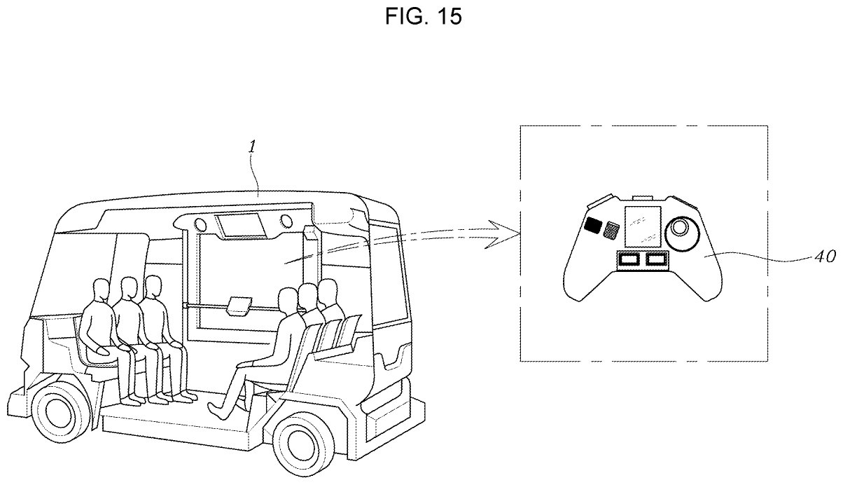

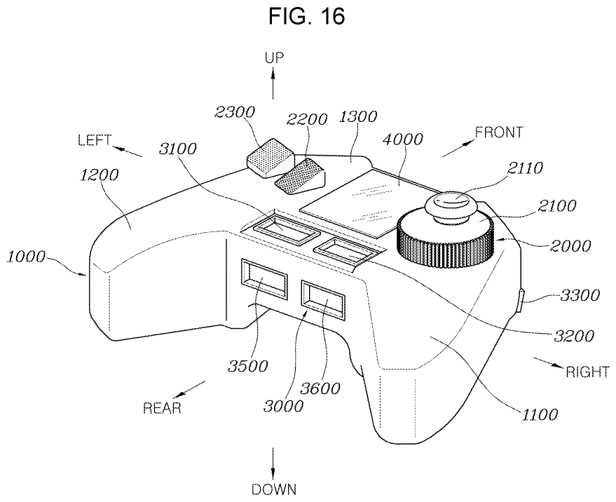

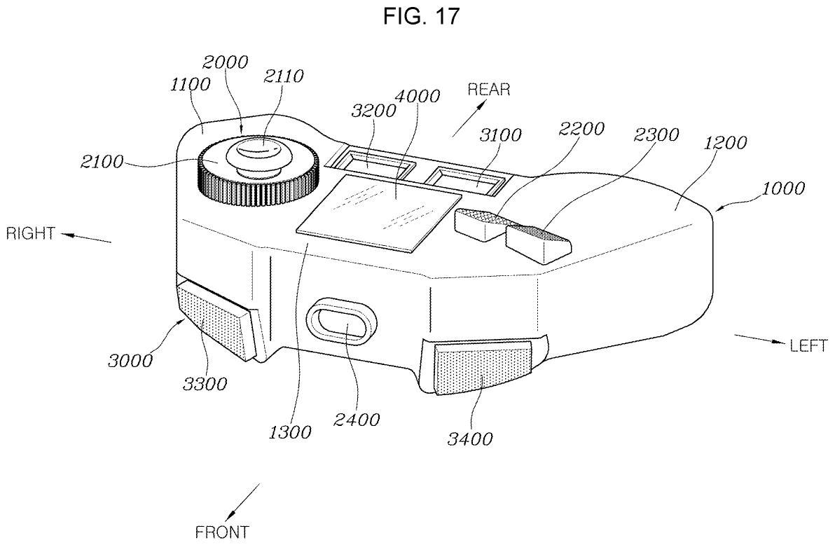

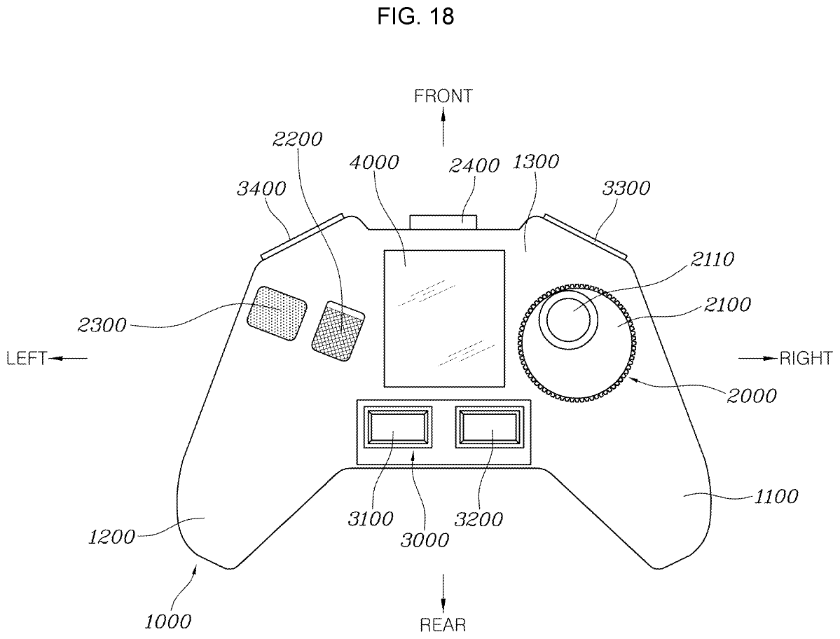

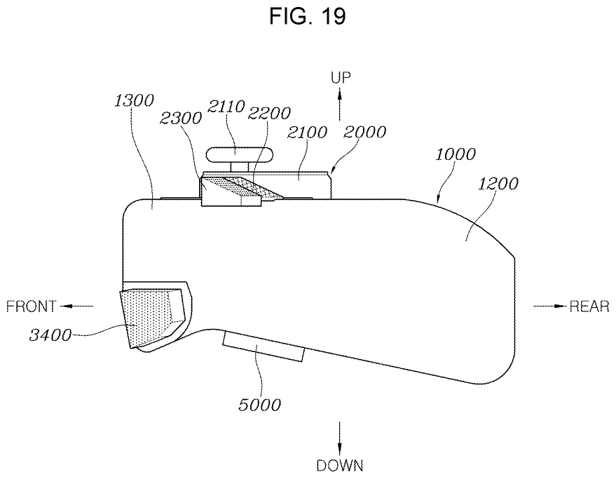

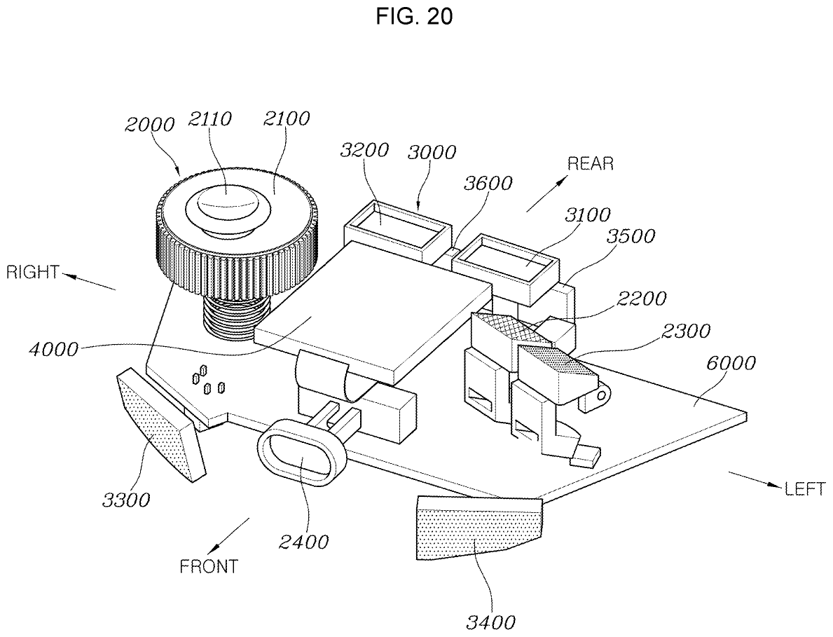

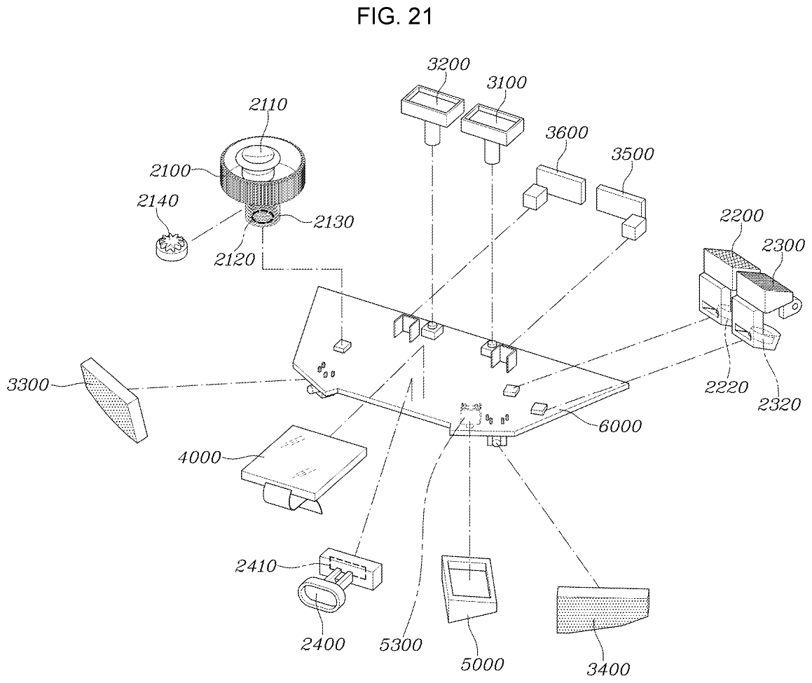

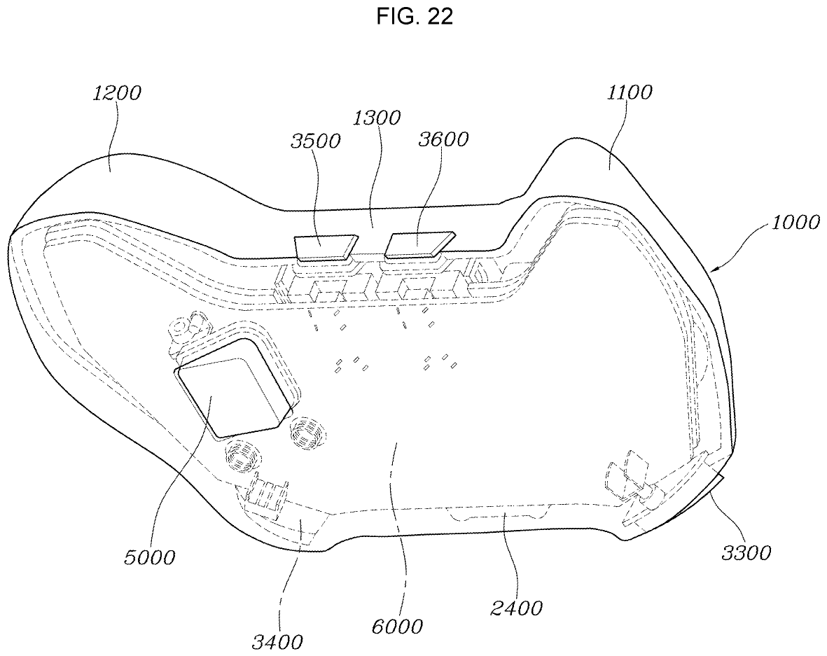

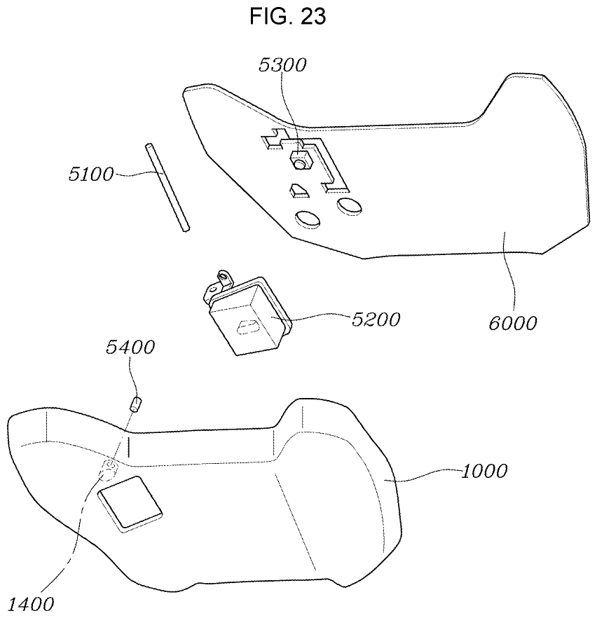

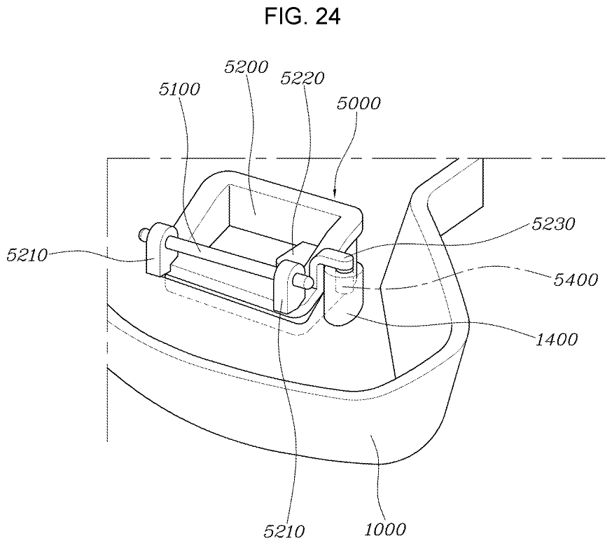

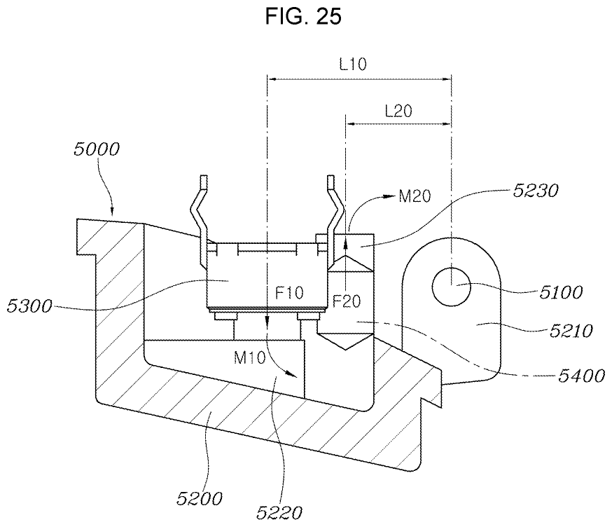

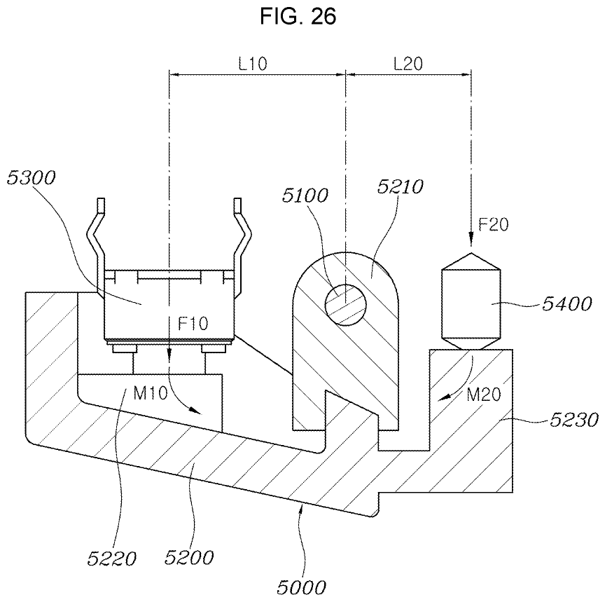

An integrated control apparatus for an autonomous driving vehicle according to various exemplary embodiments of the present disclosure is a device that is, as shown in FIGS. 15 to 26, disposed in an autonomous driving vehicle 15 and enables a manager of the vehicle to drive the vehicle in a manual driving mode by operating the device when an emergency occurs during autonomous driving.

That is, an integrated control apparatus for an autonomous driving vehicle according to an exemplary embodiment of the present disclosure is a portable two-hand operation device 40 that a user can hold and move to a desired position with both hands, may be configured to be connected to the controller of an autonomous driving vehicle and transmit a signal through a wire or using wired communication, and may be easily operated because the volume and weight are small.

That is, the two-hand operation device 40 according to various exemplary embodiments of the present disclosure may include a housing 1000 that a user holds with both hands thereof; a chassis function switch 2000 disposed on the housing 1000 and configured to be operated by a user for steering, shifting, accelerating, and braking; a normal function switch 3000 disposed on the housing 1000 and configured to be operated by a user for operating lamps, a horn, and turn signals; a display 4000 disposed on the housing 1000 and configured to visually display the information of operated switches; and a deadman switch 5000 disposed on the housing 1000 and configured to be operated by a user.

The housing 1000 of the two-hand operation device 40 according to various exemplary embodiments of the present disclosure may include a first grip 1100 that a user holds with one hand; a second grip 1200 which is spaced from the first grip 1100 and that the user holds with the other hand; and a switch section 1300 that connects the first grip 1100 and the second grip 1200 and at which the chassis function switch 2000, the normal function switch 3000, the display 4000, and the deadman switch 5000 are disposed.

Assuming a right-handed user in the following description, the user can hold the first grip 1100 with the right hand the second grip 1200 with the left hand the switch section 1300 connecting the first grip 1100 and the second grip 1200 is positioned between the right hand the left hand.

The chassis function switch 2000 includes: a steering dial switch 2100 which is disposed at the front portion of the first grip 1100 on the top portion of the switch section 1300 and that a user operates by rotating with a finger; an acceleration button switch 2200 and a brake button switch 2300 that are disposed at the front portion of the second grip 1200 on the top portion of the switch section 1300 and that a user operates by pressing with a finger; and a shift slide switch 2400 which is disposed on the front of the switch section 1300 and that a user operates by pushing or pulling with a finger.

The present disclosure is characterized in that the operation ways of the steering dial switch 2100, the acceleration button switch 2200, and the brake button switch 2300 are different. The acceleration button switch 2200 and the brake button switch 2300 are buttons that are operated to accelerate and decelerate a vehicle and are operated in the same way for consistency of operation, but they may be configured to be operated in different ways, if necessary.

A user can hold the second grip 1200 with the left hand operate the steering dial switch 2100 by rotating it with all the fingers of the right hand.

A power handle 2110 that a user can rotate with a small force with a finger thereon may be additionally provided at the steering dial switch 2100.

The top portion of the power handle 2110 is concaved so that a user can put a finger thereon, so when a user puts the thump or the index finger of the right hand on the top portion of the power handle 2110 and applies a small rotational force, the entire steering dial switch 2100 may be rotated with respect to the housing 1000.

A permanent magnet 2120 is coupled to the steering dial switch 2100 and is provided to face a Printed Circuit Board (PCB) 6000 fixed to the housing 1000. Accordingly, when a user rotates the entire steering dial switch 2100, the position of the permanent magnet 2120 is changed and the PCB 6000 generates a signal related to steering based on a change of the magnetic flux due to the position change of the permanent magnet 2120.

When a user operates the steering dial switch 2100, the steering dial switch 2100 is rotated clockwise or counterclockwise with respect to the housing 1000, and when the user releases the steering dial switch 2100, the steering dial switch 200 is rotated in the opposite direction and returned to the initial position by the spring force of a return spring 2130.

A damper 2140 is engaged with the steering dial switch 2100 like an external gear. The damper 2140 reduces the return speed by the spring force, preventing noise and shock.

The acceleration button switch 2200 and the brake button switch 2300 are disposed at the front portion of the second grip 1200 on the top portion of the switch section 1300 and are exposed upwards from the housing 1000, so a user operates the acceleration button switch 2200 and the brake button switch 2300 with the thumb of the left hand holding the second grip 1200.

To the present end, the acceleration button switch 2200 and the brake button switch 2300 are configured to be inclined at a predetermined angle in the longitudinal direction of the second grip 1200 so that a user can easily operate them with the thumb of the left hand holding the second grip 1200. Furthermore, the acceleration button switch 2200 and the brake button switch 2300 may be configured to be inclined at an angle within about 45 degrees for a user to easily operate them with the thumb of the left hand holding the second grip 1200 in consideration of the ergonomic characteristics, but the present disclosure is not limited thereto.

The brake button switch 2300 is provided at a side of the acceleration button switch 2200, and the acceleration button switch 2200 and the brake button switch 2300 may be provided in parallel with each other in consideration of ergonomic characteristics, but the present disclosure is not limited thereto.

The acceleration button switch 2200 and the brake button switch 2300 may have transverse and longitudinal lengths that are each different from each other to prevent mis-operation.

That is, in the acceleration button switch 2200 and the brake button switch 2300, the portions protruding upwards from the housing 1000 each may be formed in a rectangular shape. In the instant case, the transverse length of the acceleration button switch 2200 may be smaller than that of the brake button switch 2300, and the longitudinal length of the acceleration button switch 2200 may be greater than that of the brake button switch 2300.

Because the transverse and longitudinal lengths of the acceleration button switch 2200 and the brake button switch 2300 are each different from each other, intuitiveness may be improved, so mis-operation may be prevented.

The surface of the acceleration button switch 2200 and the surface of the brake button switch 2300 may be embossed in different ways to prevent mis-operation by a user.

That acceleration button switch 2200 and the brake button switch 2300 are provided in the same configuration. That is, the upper end portions of the acceleration button switch 2200 and the brake button switch 2300 may be rotated on the housing 1000 by rotation shafts, respectively, and a return spring is wound on the rotation shafts. First end portions of the return springs are coupled and fixed to the housing 1000 and second end portions of the return springs are coupled and fixed to the acceleration button switch 2200 and the brake button switch 2300, respectively.

Permanent magnets 2220 and 2230 are coupled to the lower end portions of the acceleration button switch 2200 and the brake button switch 2300, respectively, to face the PCB 6000.

Accordingly, when a user pressing the top portion of the acceleration button switch 2200 or the brake button switch 2300 with the thumb of the left hand holding the second grip 1200, the acceleration button switch 2200 or the brake button switch 2300 is rotated about a rotation shaft, the position of the permanent magnet 2220, 2320 is changed by a rotation of the acceleration button switch 2200 or the brake button switch 2300, and the PCB 6000 recognizes rotation of the acceleration button switch 2200 or the brake button switch 2300 from a change of the magnetic flux due to the position change of the permanent magnet 2220, 2320 and generates a signal related accelerating or a signal related to braking.

The acceleration button switch 2200 and the brake button switch 2300 are pedal-type button switches of which the upper end portions may be rotated on a rotation shaft with respect to the housing 1000.

Because the shift slide switch 2400 is provided on the front of the switch section 1300, a user can operate the shift slide switch 2400 by holding the second grip 1200 with the left hand pushing or pulling the shift slide switch 2400 in the left and right direction with the thumb or the index finger of the right hand.

The shift slide switch 2400 is configured to slide left and right with respect to the housing 1000 and has a return spring, so when a user releases the shift slide switch 2400, the shift slide switch 2400 may be returned to a neutral position.

The shift slide switch 2400 also has a permanent magnet 2410 and the permanent magnet 2410 is provided to face the PCB 6000. Accordingly, when a user moves the shift slide switch 2400 by pushing or pulling, the position of the permanent magnet 2410 is changed and the PCB 6000 recognizes movement of the shift slide switch 2400 from a change of the magnetic flux due to the position change of the permanent magnet 2410 and generates a signal related to shifting.

The normal function switch 3000 includes: an emergency light switch 3100 and a horn switch 3200 that are disposed at the rear portion on the top portion of the switch section 1300 and spaced apart left and right from each other; a right turn signal switch 3300 disposed ahead of the steering dial switch 2100 on the front of the switch section 1300; a left turn signal 3400 disposed ahead of the acceleration button switch 2200 and the brake button switch 2300 on the front of the switch section 1300; and a headlamp switch 3500 and a fog lamp switch 3600 that are positioned on the rear of the switch section 1300 and spaced apart left and right from each other.

The emergency light switch 3100, the horn switch 3200, the right turn signal switch 3300, the left turn signal 3400, the headlamp switch 3500, and the fog lamp switch 3600 are all tact switches that are pressed to be operated by a finger of a user. A tact switch is small in size and has a rubber spring therein, so it may be returned to the initial position and generates a signal in a contact point type when it is operated.

In normal functions of a vehicle, the emergency light switch 3100 and the horn switch 3200 that are frequently used are disposed at the rear portion with respect to the display 4000 on the top portion of the switch section 1300, and are positioned between the steering dial switch 2100 and acceleration button switch 2200 and the brake button switch 2300.

A user can hold the second grip 1200 with the left hand easily operate the emergency light switch 3100 or the horn switch 3200 after taking the right hand off the steering dial switch 2100 while operating the acceleration button switch 2200 or the brake button switch 230 with a finger of the left hand.

For reference, when a user operates the two-hand operation device 40, the autonomous driving vehicle is driven at a low speed, so that the user can take the right hand off the steering dial switch 2100 and then operate the emergency light switch 3100 or the horn switch 3200 with the thumb or the index finger of the right hand while operating the acceleration button switch 2200 or the brake button switch 230 with a finger of the left hand holding the second grip 1200.

The headlamp switch 3500 and the fog lamp switch 3600 that are used under specific conditions of the normal functions of a vehicle are positioned on the rear of the switch section 1300 where they are minimally exposed to a user.

A user can hold the second grip 1200 with the left hand operate the headlamp switch 3500 or the fog lamp switch 3600 with the thumb or the index finger of the right hand after taking the right hand off the steering dial switch 2100 while operating the acceleration button switch 220 or the brake button switch 230 with a finger of the left hand.

In the normal functions of a vehicle, the right turn signal switch 3300 and the left turn signal switch 3400 that are most frequently used may be operated by the middle finger of the right hand the middle finger of the left hand of a user, respectively.

The right turn signal switch 3300 should be able to be operated by a finger of the right hand of a user even while the user operates the steering dial switch 2100 with the right hand. To the present end, the right turn signal switch 3300 is disposed ahead of the steering dial switch 2100 on the front of the switch section 1300.

The left turn signal switch 3400 should be able to be operated by a finger of the left hand of a user even while the user operates the acceleration button switch 2200 or the brake button switch 2300 with the left hand. To the present end, the left turn signal switch 3400 is disposed ahead of the acceleration button switch 2200 and the brake button switch 2300 on the front of the switch section 1300.

The display 4000 may be disposed between the steering dial switch 2100 and the acceleration button switch 2200 and between the emergency light switch 3100 and the horn switch 3200 so that a user can more easily visually recognize the display 4000.

The two-hand operation device 40 according to an exemplary embodiment of the present disclosure includes a PCB 600 fixed to the housing 1000 and generating operation signals for the chassis function switch 2000 (the steering dial switch, the acceleration button switch, brake button switch, and the shift slide switch), the normal function switch 3000 (the emergency light switch, horn switch, right turn signal switch, left turn signal switch, headlamp switch, and fog lamp switch), and the deadman switch 5000.

The deadman switch 5000 of the two-hand operation device 40 is disposed on the bottom portion of the housing 1000, that is, is disposed on the bottom portion of the housing 1000 to be positioned under the acceleration button switch 2200 and the brake button switch 2300.

A user can rotate and operate the steering dial switch 2100 using the entire right hand. Accordingly, when the deadman switch 500 is disposed under the steering dial switch 2100 on the bottom portion of the housing 1000, it may be difficult to operate the deadman switch 5000.

Therefore, in the two-hand operation device 40, the deadman switch 5000 is disposed under the acceleration button switch 2200 and the brake button switch 2300 on the bottom portion of the housing 1000, whereby a user can more conveniently operate the deadman switch 5000, and accordingly, convenience of operation may be remarkably improved.

A user can operate the deadman switch 5000 of the two-hand operation device 40 by pressing the deadman switch 5000 with any one of the middle finger, the ring finger, and the little finger or one or more of the middle finger, the ring finger, and the little finger of the left hand while holding the second grip 1200 with the left hand.

The deadman switch 5000 is a switch which is operated by a user for steering, shifting, accelerating, and braking when the chassis function switch 2000 is operated. Accordingly, the present disclosure is characterized in that only when a user operates the chassis function switch 2000 after operating the deadman switch 5000, the function of the operated chassis function switch 2000 is performed.

When a user operates the chassis function switch 2000 without operating the deadman switch 5000, the function of the operated chassis function switch 2000 is not performed and a warning (texts, symbols, etc.) is provided to the user through the display 4000.

That is, the functions corresponding to steering, shifting, accelerating, and braking of a vehicle are important main factors that are directly connected with safety of passengers. Accordingly, a user has to operate a desired chassis function switch 2000 after operating the deadman switch 5000 first when operating the chassis function switch 2000 in consideration of safety of passengers.

However, when a user operates the normal function switch 3000, the function of the operated normal function switch is immediately performed regardless of operation of the deadman switch 5000.

That is, the functions corresponding to lamps, a horn, and turn signals of a vehicle are sub-factors that are not directly connected with safety of passengers. Accordingly, when a user operates the normal function switch 3000 after operating the deadman switch 5000, the function of the operated normal function switch 3000 is immediately performed, and even though a user operates the normal function switch 3000 without operating the deadman switch 5000, the function of the operated normal function switch 3000 is immediately performed.

The deadman switch 5000 includes: a hinge pin 5100 coupled to the housing 1000 in the front and rear direction thereof; a deadman key 5200 having a first side coupled to the hinge pin 5100, having a second side laterally elongated, and configured to rotate on the hinge pin 5100 with respect to the housing 1000 when it is operated; and a tact switch 5300 connected to the PCB 6000 of the two-hand operation device 40 and outputting a signal by coming in contact with the deadman key 5200 when the deadman key 5200 is operated.

The deadman key 5200 is formed like a lever and is rotated on the hinge pin 5100 coupled to the first side thereof. Such a rotation type has an advantage that there is no gap in comparison to a sliding type structure, so the present type is suitable for the deadman key.

The tact switch 5300 is a switch configured to operate only when coming in contact with the deadman key 5200, is small in size, and includes a rubber spring therein, so it has a structure which may be returned. Furthermore, the tact switch 830 outputs a signal in a contact point type when it is operated.

The deadman switch 5000 according to an exemplary embodiment of the present disclosure further includes a rubber damper 5400 coupled to a protrusion 1400 of the housing 1000 and configured to prevent noise and a gap and to fix the position of the deadman key 5200 by coming in contact with the deadman key 5200 when the deadman key 5200 is operated.

Although a spring may be used instead of the rubber damper 5400 to prevent a gap around the deadman key 5200, the rubber damper 5400 has an advantage that the price is low and the layout may be minimized in comparison to a spring.

Referring to FIG. 25, the position of the deadman key 5200 is fixed by the elastic force F10 of the tack switch 5300 and the reaction force F20 of the rubber damper 5400.

The magnitude of the moment M10 by the elastic force F10 of the tack switch 5300 and the magnitude of the moment M20 by the reaction force F20 of the rubber damper 5400 are the same, and the moments M10 and M20 act in opposite directions with the hinge pin 5100 therebetween.

Accordingly, the deadman key 5200 is maintained at a predetermined return position when a user does not operate the deadman key 5200.

F10*L10=F20*L20, that is, M10=M20.

The deadman key 5200 has: a hinge portion 5210 at side to which the hinge pin 5210 is coupled; a switch contact protrusion 5220 protruding toward the tact switch 5300 at another side of the deadman key 5200 spaced from the hinge portion 5200 and coming in contact with the tact switch 5300 when the deadman key 5220 is operated; and a damper contact portion 5230 protruding at the side of the deadman key 5200 where the hinge portion 5120 is positioned, and coming in contact with the rubber damper 5400 when the deadman key 5200 is operated.

The present disclosure is characterized in that the distance from the hinge portion 5210 to the switch contact portion 5220 is greater than the distance from the hinge portion 5210 to the damper contact portion 5230.

That is, the rubber damper 5400 is positioned close to the hinge portion 5210 to prevent noise and a gap, and the switch contact portion 5220 is positioned far from the hinge portion 5210 to improve convenience of operation.

According to an exemplary embodiment of the present disclosure, the deadman key 5200 may be configured so that the damper contact portion 5230 is positioned between the hinge portion 5210 and the switch contact protrusion 5220, as shown in FIG. 25, or may be configured so that the switch contact protrusion 5220 and the damper contact portion 5230 are disposed at positions spaced at a side and another side apart from the hinge portion 5210, respectively, as shown in FIG. 26.

As described above, the integrated control apparatus for an autonomous driving vehicle according to an exemplary embodiment of the present disclosure includes the one-hand operation device 10 that a user holds and operates with one hand the two-hand operation device 40 that a user holds and operates with both hands, in which the deadman switch 800 is disposed on the front surface of the grip 110 of the housing 100 under the acceleration trigger switch 400 in the one-hand operation device 10 and the deadman switch 5000 is disposed on the bottom portion of the housing 1000 under the acceleration button switch 2200 and the brake button switch 2300 in the two-hand operation device 40. Accordingly, there is an advantage that a user can more conveniently operate the deadman switch 5000, whereby convenience of operation may be improved.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An integrated control apparatus which is provided in an autonomous driving vehicle so that a user can operate the integrated control apparatus to change an autonomous driving mode into a manual driving mode, the integrated control apparatus comprising:
a housing of a one-hand operation device that the user holds and operates with one hand thereof; and
a steering dial switch, a shift slide switch, an acceleration trigger switch, a brake button switch, and a deadman switch that are disposed at the housing,
wherein the deadman switch is disposed at a portion of the housing that a driver holds.

2. The integrated control apparatus of claim 1, wherein the one-hand operation device includes:
a grip which is configured to be held by one hand of the user and at which the deadman switch is disposed; and
a switch section which is elongated in a longitudinal direction of the grip and at which the steering dial switch, the shift slide switch, the acceleration trigger switch, and the brake button switch are disposed.

3. The integrated control apparatus of claim 1, wherein the one-hand operation device includes a printed circuit board (PCB) fixed to the housing and configured for generating operation signals for the steering dial switch, the shift slide switch, the acceleration trigger switch, the brake button switch, and the deadman switch.

4. The integrated control apparatus of claim 1, wherein the deadman switch includes:
a hinge pin coupled to left and right of the grip of the housing;
a deadman key coupled to the hinge pin, elongated up and down, and configured to rotate on the hinge pin with respect to the housing when being operated; and
a tact switch connected to a PCB of the one-hand operation device and configured to output a signal by coming in contact with the deadman key when the deadman key is operated.

5. The integrated control apparatus of claim 4, further including a rubber damper coupled to the deadman key and configured to prevent noise and a gap and to fix a position of the deadman key by coming in contact with a housing protrusion formed in the housing when the deadman key is operated.

6. The integrated control apparatus of claim 5,
wherein the position of the deadman key is fixed by an elastic force of the tact switch and a reaction force of the rubber damper, and
wherein a magnitude of a moment by the elastic force of the tack switch and a magnitude of a moment by the reaction force of the rubber damper are a same when the deadman key is not operated.

7. The integrated control apparatus of claim 5, wherein the deadman key includes:
a hinge portion at a first end portion to which the hinge pin is coupled;
a switch contact protrusion protruding toward the tact switch at a position spaced from the hinge portion and coming in contact with the tact switch when the deadman key is operated; and
a damper coupling portion protruding away from the switch contact protrusion from the hinge portion and coupled with the rubber damper.

8. The integrated control apparatus of claim 5, wherein the deadman key includes:
a hinge portion at a first end portion to which the hinge pin is coupled;
a switch contact protrusion protruding toward the tact switch at a position spaced from the hinge portion and coming in contact with the tact switch when the deadman key is operated; and
a damper coupling portion protruding from the hinge portion toward the switch contact protrusion and coupled with the rubber damper.

9. The integrated control apparatus of claim 7, wherein a distance from the hinge portion to the switch contact protrusion is greater than a distance from the hinge portion to the rubber damper.

10. The integrated control apparatus of claim 7,
wherein a left and right length and a front and rear length of the first end portion at which the hinge portion of the deadman key is positioned are smaller than those of a second end portion at which the switch contact portion is positioned to prevent interference with a surrounding; and
wherein a left and right length and a front and rear length of the second end portion at which the switch contact portion is positioned are greater than those of the first end portion at which the hinge portion is positioned for convenience of operation.

11. An integrated control apparatus which is provided in an autonomous driving vehicle so that a user can operate the integrated control apparatus to change an autonomous driving mode into a manual driving mode, the integrated control apparatus comprising:
a housing of a two-hand operation device so that the user holds and operates with both hands thereof; and
a steering dial switch, an acceleration button switch, a brake button switch, a shift slide switch, and a deadman switch that are disposed at the housing,
wherein the deadman switch is disposed at a portion of the housing that a driver holds.

12. The integrated control apparatus of claim 11, wherein the deadman switch is disposed on a bottom portion of the housing to be positioned under the acceleration button switch and the brake button switch.

13. The integrated control apparatus of claim 11, wherein the housing of the two-hand operation device includes:
a first grip that the user holds with one hand;
a second grip which is spaced from the first grip and that the user holds with the other hand; and
a switch section that connects the first grip and the second grip to each other and at which the steering dial switch, the acceleration button switch, the brake button switch, the shift slide switch, the deadman switch, and a display are disposed.

14. The integrated control apparatus of claim 13,
wherein the steering dial switch protrudes upwards from the switch section, is disposed at a front portion of the first grip, and is configured to be rotated to be operated by the user,
wherein the acceleration button switch and the brake button switch protrude upwards from the switch section, are disposed at a front portion of the second grip, and are pressed to be operated by the user, and
wherein the shift slide switch protrudes forward from a front of the switch section and is selectively pushed or pulled to be operated by the user.

15. The integrated control apparatus of claim 13, wherein the two-hand operation device includes a printed circuit board fixed to the housing and configured for generating operation signals for the steering dial switch, the acceleration button switch, the brake button switch, the shift slide switch, and the deadman switch.

16. The integrated control apparatus of claim 15, wherein the deadman switch includes:
a hinge pin coupled to the housing in a front and rear direction thereof;
a deadman key including a first side coupled to the hinge pin, including a second side laterally elongated, and configured to rotate on the hinge pin with respect to the housing when being operated; and
a tact switch connected to the PCB of the two-hand operation device and configured to output a signal by coming in contact with the deadman key when the deadman key is operated.

17. The integrated control apparatus of claim 16, further including a rubber damper coupled to the housing and configured to prevent noise and a gap and to fix a position of the deadman key by coming in contact with the deadman key when the deadman key is operated.

18. The integrated control apparatus of claim 16,
wherein the position of the deadman key is fixed by an elastic force of the tact switch and a reaction force of the rubber damper, and
wherein a magnitude of a moment by the elastic force of the tack switch and a magnitude of a moment by the reaction force of the rubber damper are a same when the deadman key is not operated.

19. The integrated control apparatus of claim 17, wherein the deadman key includes:
a hinge portion at a first end portion to which the hinge pin is coupled;
a switch contact protrusion protruding toward the tact switch at the second side of the deadman key spaced from the hinge portion, and coming in contact with the tact switch when the deadman key is operated; and
a damper contact portion protruding from the first side of the deadman key at which the hinge portion is positioned, and coming in contact with the rubber damper when the deadman key is operated.

20. The integrated control apparatus of claim 19, wherein a distance from the hinge portion to the switch contact protrusion is greater than a distance from the hinge portion to the damper contact portion.
